(19) United States
(12) Patent Application Publication
(10) Pub. No.: US 2022/0340466 A1
(43) Pub. Date: Oct. 27, 2022

(54) Laundry Wastewater Treatment Methods and Systems

(71) Applicants: Tom Cartwright, Punta Gorda, FL (US); Lawrence Verdone, JR., Port St. Lucie, FL (US)

(72) Inventors: Tom Cartwright, Punta Gorda, FL (US); Lawrence Verdone, JR., Port St. Lucie, FL (US)

(21) Appl. No.: 17/728,006

(22) Filed: Apr. 25, 2022

Related U.S. Application Data
(60) Provisional application No. 63/179,838, filed on Apr. 26, 2021.

(51) Int. Cl. C02F 9/00; B01D 33/03; B01D 29/11; B01D 39/20

(52) U.S. Cl. CPC C02F 9/00; B01D 33/0346; B01D 29/11; B01D 39/20; C02F 2303/26; C02F 2103/002

(57) ABSTRACT

Apparatus and systems for laundry wastewater treatment are provided. Generally, systems include one or more grinder pumps for receiving raw wastewater from laundry operations, a lint remover in fluid communication with the grinder pumps, a sediment filter in fluid communication with the lint remover, an ozone treatment chamber in fluid communication with the sediment filter, and a carbon filter. Methods can provide for continuous treatment of laundry wastewater that can be reused in laundry operations, or passed to a wastewater stream (such as sewage).

### CROSS-REFERENCE TO RELATED APPLICATIONS

This application claims priority to U.S. Application Ser. No. 63/179,838, filed 26 Apr. 2021, Attorney Docket No. BGM0005/P1, entitled “Laundry Wastewater Treatment Methods and Systems,” the entire disclosure of which is incorporated herein by reference for all purposes.

### FIELD

Laundry wastewater treatment methods and systems are described. More specifically, systems for onsite recovery of wastewater in laundry operations are described.

### BACKGROUND

Wastewater treatment is an ancient technique. However, increasing water pollution and water demand in the last few decades have highlighted the importance of conservation and wastewater treatment. Wastewater can be categorized according to the source of generation; laundry wastewater is one major source. Wastewater produced by the laundry process possesses energy (heat), suspended solids or particulates (including lint, soil, hair, soap scrim and the like), dyes, finishing agents and other chemicals from detergents. In another aspect, laundry wastewater contains organic (soaps, detergents, chlorinated and aromatic solvents and biological substance, fats, grease, and oil) and inorganic (heavy metals, sand and soil dust, metal ions and particles) substances that can make treatment difficult.

Laundry uses can be categorized as domestic (household use), commercial, and industrial. Commercial laundries often work in self-service mode (self-service laundromat operations), while industrial laundries include large users such as hospitality (such hotels, restaurants, bars), healthcare (hospitals, nursing homes), military, correctional, textile, and the like.

Many state and local environmental agencies have enacted environmental regulations or expanded existing regulations to limit the amount and content of wastewater contaminants discharged into the environment. Regulations are generally directed toward commercial enterprises that create various wastes as a by-product of manufacture or of doing business. The commercial laundry industry and commercial laundromats, in particular, are affected by regulation limiting the amount of suspended solids or particulate contaminants contained in wastewater that is discharged into the ground water and/or municipal sewage system. To meet environmental regulatory requirements, a certain amount of the particulate contaminants in the wastewater must be removed.

For example, laundromats in some locales face the following wastewater effluent maximum permissible criteria:

| | | |
|---|---|---|
| MBAS | 1.0 | ppm |
| TSS | 30.0 | ppm |
| TDS | 1000 | ppm |
| Oil and grease | 15 | ppm |

| | |
|---|---|
| pH | 6.5-8.5 |

“MBAS” refers to methylene blue active substances, “TSS” refers to total suspended solids, and “TDS” refers to total dissolved solids, as determined by conventional testing methods well known in the art. “FOG” refers to fats, oils, and grease.

For laundromats, such criteria can be a significant challenge, as a typical laundromat effluent discharge can be in the range of about 8,000 to 35,000 gallons per day and can have the following broad range of characteristics:

| MBAS | 35-130 | ppm |
|---|---|---|
| TSS | 70-130 | ppm |
| TDS | 350-775 | ppm |
| Oil and grease | 15 | ppm |
| pH | 8.5-11.0 | |
| FOG | 30-80 | ppm |

Differences can be seen between commercial laundries versus laundromats.

Commercial laundries can select and control the specific detergent and concentrations of same. In contrast, laundromats experience diverse detergents used in diverse concentrations. Further, detergent concentrations in the effluent can vary daily, for example, due to higher use on weekends versus weekdays.

### SUMMARY

In some implementations, methods and systems for continuous treatment of wastewater in laundry operations are provided. In some aspects, treatment of laundry wastewater provides methods and systems for wastewater recovery. As described herein, recovery of laundry wastewater includes returning the water to a state (for example, total solids content and total organic material content) that is suitable for reuse in laundry operations. The basic concept of a water reuse system (WRS) is to process the “grey” water from a laundry washer (also referred to herein as raw water or effluent) through a filtration system and recycle it back into the wash process instead of routing wastewater out of the facility and on to the public sewage treatment facility. In some aspects, treatment systems and methods can be used to provide onsite alternative water reuse solutions that intentionally capture, treat, and utilize wastewater for reuse at commercial and industrial laundry operations.

Additional features of the design relate to improved efficiency. Generally speaking, wastewater recovery systems described herein can provide an arrangement that reduces the number and complexity of componentry. In some implementations, wastewater treatment systems can eliminate many of the components of wastewater recovery systems. In some aspects, methods and systems for treatment of laundry wastewater do not require treatment with ultraviolet light.

In some aspects, systems are easily and inexpensively manufactured, highly efficient in operation, and require little maintenance during use. In some implementations, systems described herein open and close sewer drain valves to maintain uninterrupted wash production.

There are many benefits to using a water reuse system, including, for example, one or more of the following: reduced fresh water usage, reduced detergents and toxins discharge/release associated with laundry wastewater, reduced wastewater discharge, reduced energy consumption, and reduced greenhouse gas emissions associated with laundry water heating. In some implementations, laundry wastewater is selectively mechanically filtered, ozone treated, separated by adsorption, and pumped back into the laundry operation.

Further benefits that can be realized in accordance with some aspects include reduced water usage, wastewater discharge, and energy costs. Methods and systems described herein are capable of accepting a large flow rate of laundry wastewater and are capable of removing the relatively small suspended particulate contaminants within the effluent. In some aspects, continuous treatment methods and systems are provided that can accommodate these high flow rate and/or high usage conditions. In some implementations, the system is configured to minimize clogging of filter elements.

In some implementations, wastewater recovery systems comprise:
one or more grinder pumps for receiving raw wastewater from laundry operations;
a lint remover in fluid communication with the grinder pumps;
a sediment filter in fluid communication with the lint remover;
an ozone treatment chamber in fluid communication with the sediment filter; and
a filter —Ag/carbon filter in fluid communication with the sediment filter.

In some implementations, systems and methods described herein can provide a single pass water reuse system. Connected to and utilized by the elements of the water treatment system are pumps which are used to move water through the system. In some aspects, wastewater recovery systems are continuous.

Optional features include one or more of the following: HDPE Spheres, a primary control panel, or water recycling.

In some implementations, methods for treatment of laundry wastewater are provided, the methods including steps of:
subjecting effluent from laundry operations to grinder pumps to reduce particulate size in the effluent;
subjecting the effluent to a lint remover;
separating debris of a predetermined size from the effluent by subjecting the effluent to a multimedia filter;
ozonating the effluent within an ozone treatment chamber; and
subjecting the effluent to a filter —Ag/carbon filter.

Applications of concepts described herein will be readily appreciated in the field of wastewater treatment systems for laundry operations.

### BRIEF DESCRIPTION OF THE FIGURES

The disclosure may be more completely understood in consideration of the accompanying drawings, in which:

FIG. 1 is a schematic diagram of a wastewater treatment system in accordance with various implementations described herein.

The figures are not necessarily to scale.

### DETAILED DESCRIPTION

In the following description, reference is made to the accompanying set of drawings that form a part hereof and in which are shown by way of illustration of a specific embodiment. It is to be understood that other embodiments are contemplated and may be made without departing from the scope or spirit of the present disclosure. The following detailed description, therefore, is not to be taken in a limiting sense.

Generally, when referring to the methods and systems herein, reference will be made to wastewater treatment systems. Laundry applications of the wastewater treatment systems will be utilized to describe inventive concepts, as these applications are useful to highlight features and advantages. However, it will be understood upon review of the present specification that wastewater treatment systems described herein can be adapted for additional uses outside laundry applications. In addition, applications in commercial and industrial laundry wastewater treatment will be highlighted, as the benefits and advantages of treatment methods and systems can be readily appreciated. However, it is understood that methods and systems described herein can also find utility in domestic laundry operations.

In some aspects, wastewater recovery systems comprise:
one or more grinder pumps for receiving raw wastewater from laundry operations;
a lint remover in fluid communication with the grinder pumps;
a sediment filter in fluid communication with the lint remover;
an ozone treatment chamber in fluid communication with the sediment filter; and
a filter —Ag/carbon filter in fluid communication with the sediment filter.

In additional aspects, some implementations provide wastewater treatment systems that reduce or eliminate the number of components in the system, thereby providing a more robust and easily maintained system. In these aspects, ultraviolet light treatment and clay filters commonly used in wastewater treatment systems are not required or included, contributing to the overall streamlined nature of the system. In still further aspects, wastewater treatment systems described herein can reduce the number of required components, while providing enhanced performance of the wastewater treatment system.

These and other features of the wastewater treatment systems will now be described.

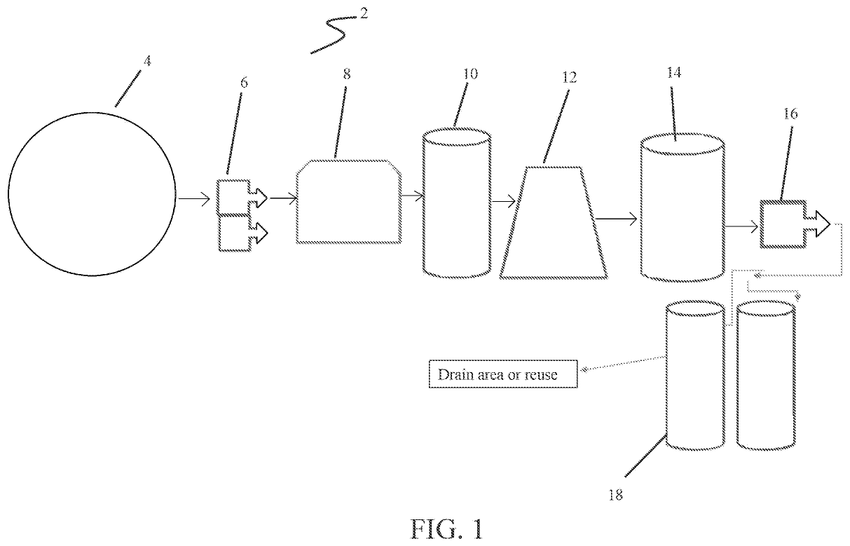

Referring to FIG. 1, a wastewater treatment system 2 is schematically shown which generally includes a raw water supply 4, grinder pumps 6, lint remover 8, sediment filter 10, ozone generator 12, ozone treatment chamber 14, pump 16, and one or more filter —Ag/carbon filters 18. Generally speaking, components of the system can be connected via conduit that is configured to convey fluid from one location to another in a watertight structure. In some aspects, the conduit is constructed of an inert, nonbiodegradable material, such as an inert polymer (for example, polyvinylchloride (PVC)), or metal.

In some implementations, the overall size of the wastewater treatment system is designed to accommodate the washing machine load capacity of the facility. Load capacity determines the peak water flow through the wastewater treatment system and is calculated by adding the pounds capacity per machine and multiplying it by the average amount of water used by the washing machines per pound of dry laundry. That number is then divided by the number of minutes between loads. For example, three 300-pound washers represent 2,250 gallons per washing cycle. With a 45-minute cycle, the system's peak water flow is 50 gallons per minute (GPM). In this instance, a 50 GPM system would be recommended.

Raw water supply 4 can be connected to at least one (and optionally a plurality) of conventional washing machines (not shown). The washing machines typically discharge water at temperatures in a range of about 100 degrees Fahrenheit to about 140 degrees Fahrenheit. The raw wastewater discharged (also referred to herein as laundry effluent) is contaminated with particulate matter, along with detergents and other organic matter.

Raw water is pulled into Grinder pumps 6, which are designed to handle water that includes large particulate matter. Grinder pumps 6 macerate waste and grind large particulate matter into smaller particles or a fine slurry. Suitable grinder pumps can be semi-positive displacement (SPD) or centrifugal. Grinder pumps 6 are constructed of a suitable durable material, such as fiberglass, high-density polyethylene (HDPE) or fiberglass-reinforced polyester (FRP) and include an inlet opening and a discharge opening. Conduit from the raw water supply 4 is connected to the inlet. Suitable grinder pumps 6 can be selected to have desired pump horsepower, rated voltage, single-phase or multiple-phase operation, switch actuation (tether float or vertical float), body material (such as cast iron or stainless steel), flow rate (typically measured at 10 feet of head), maximum head, impeller material, and footprint within the system. Suitable grinder pumps can be obtained from such manufacturers as W.W. Grainger, Inc., Pentair, Zoeller Company, and Liberty Pumps.

Lint Remover 8. After water is processed through the grinder pumps 6, it is directed into a lint remover 8. Lint remover 8 can be provided as a screen filter, also known as a vibrating filter screen or lint shaker. Lint remover 8 is a filter that catches the lint and larger particles while allowing water and smaller particles to pass through. All oversized material (such as lint, threads, hair, and other elements) travels to a discharge chute where it can be disposed of properly. Suitable shaker screens can be selected in appropriate mesh sizes and overall diameter, such as 24, 30, 40, 48 or 60 inches. In some aspects, lint remover 8 can be provided as a 25 GPM lint shaker.

Suitable lint shakers 8 can be obtained from such manufacturers as Midwestern Industries, Inc., TecScrn International Ltd., and Demco. Alternatively, lint remover 8 can be provided as bladders or bag filters.

After passing through lint remover 8, water then passes to Sediment Filter 10. In some aspects, the sediment filter 10 comprises a 50-micron sediment filter. This filter removes all particulates 50 microns (50μ) in size and larger, while allowing smaller particles to pass through, including organics. Sediment filter 10 can comprise a mixed-media or single-media filter, including, for example, sand.

Water from sediment filter 10 next moves to ozone treatment chamber 14, where it is contacted with ozone from ozone generator 12. Ozone is applied as a gas to water in treatment chamber 14, where it can serve as a disinfectant (destroy bacteria and viruses), and oxidant (oxidizing surfactants present in the water as a result of cleaning chemicals found in detergents). Ozone is a powerful oxidant that can oxidize heavy metals (such as iron and manganese) and can liberate organically bound heavy metals, which otherwise are not easily removed.

Suitable ozone generators include voltage and frequency units. Electrical discharge method is the most common energy source used to produce ozone. Extremely dry air or pure oxygen is exposed to a controlled, uniform high-voltage discharge at a high or low frequency. The dew point of the feed gas must be −60° C. (−76° F.) or lower. The gas stream generated from air will contain about 0.5 to 3.0% ozone by weight, whereas pure oxygen will form approximately two to four times that concentration. Any of several known ozone generators are suitable for use in connection with methods and systems described herein, such as that manufactured by Ozonia, Inc.

After generation, ozone is fed into a down flow treatment chamber containing the wastewater to be treated. The main purpose of the contactor is to transfer ozone from the gas bubble into the liquid while providing sufficient contact time for disinfection and oxidation of desired organic materials. Commonly used contactor types include diffused pulse (co-current and counter-current), positive pressure injection, negative pressure (Venturi), mechanically agitated, and packed tower. Because ozone is consumed quickly, it is typically contacted uniformly in a near plug flow contactor.

Ozone is a microcoagulant and binds to particles, causing them to coagulate and float. Optionally, a polymer coagulant can be added to assist in coagulation if there are sufficient fats, oils, and/or grease in the effluent (for example, where clothes are soiled with grease or oil). When included, the polymer can be a cationic polymer, such as those commercially available from CIBA Specialty Chemicals (Suffolk, Va.).

In some implementations, off-gases from the treatment chamber are treated to destroy any remaining ozone before release into the atmosphere. Additional catalysts such as magnesium dioxide can be utilized to neutralize any collected off gassed ozone from any of the system components and ensure the ozone is destroyed before any ozone gas would reach the atmosphere. Therefore, it is desirable to maintain an optimal ozone dosage for efficiency. When pure oxygen is used as the feed-gas, the off-gases from the treatment chamber can be recycled to generate ozone or for reuse in the treatment chamber. In some implementations, the ozone off-gases that are not used are sent to an ozone destruction unit or are recycled.

In some aspects, the parameters of dosage, mixing and contact time can be controlled to provide efficient ozonation. In some aspects, an ozone treatment system strives for maximum solubility of ozone in wastewater, as disinfection and organic oxidation depend upon the transfer of ozone to the wastewater. The amount of ozone that will dissolve in wastewater at a constant temperature is a function of the partial pressure of the gaseous ozone above the water or in the gas feed stream.

Contact time in the treatment chamber can take into account the chamber volume, gas feed rate, and expected content of the water. In some aspects, treatment time is about 10 to about 30 minutes.

In some aspects, ozone treatment chamber 14 is constructed of a material that is corrosion-resistant (stable to oxidation), such as stainless steel.

Pump 16 delivers water from the ozone treatment chamber 14 to the filter —Ag/carbon tanks 18.

Filter —Ag/Carbon tanks 18. In some implementations, carbon filtration coupled with Filter —Ag can be the final step in the overall laundry wastewater treatment process. In this step, carbon removes any remaining organic compounds from the water. In some aspects, treatment systems and methods utilize a multi-media down flow granular activated carbon (GAC) filter that includes raw organic materials (coconut shells) that are high in carbon, in combination with sediment filtration, to reduce chemicals and debris in the water.

In some implementations, heat, in the absence of oxygen, is used to increase (activate) the surface area of the carbon. The activated carbon removes certain chemicals that are dissolved in water passing through a filter containing GAC by trapping (adsorbing) the chemical in the GAC. The size and components of the filter —Ag/carbon filter can be selected based upon the type and concentration of contaminants in the laundry wastewater. Typical micron ratings are in the range of about 0.5 μm to about 50 μm. In some aspects, one or more filter —Ag/carbon filter tanks 18 can be included in the wastewater treatment system. The number of filter —Ag/carbon filter tanks utilized can depend upon the anticipated contaminant load in the wastewater.

Multi-media filters can be configured to contain filter bed configurations designed to meet specific needs. In some aspects, a filter bed composed of 40% low density material, and 60% high density material can be utilized.

A properly designed multi-media system can maintain its unique inverse void gradation and provide superior performance even after long periods of use in backwash. This stable condition of large grains above finer ones can be achieved by the use of materials of different sizes and specific gravities.

Contact times in the filter —Ag/carbon filter can range from about 1 to about 3 minutes.

In some aspects, the multimedia filter can be constructed to hold a medium for removing contaminants such as suspended solids and hydrocarbons. The medium contained in the multimedia filter can have a diameter in a range of ⅛″ to about 2″, or a material proven to possess the same filtering capabilities. The type and size of media within the filter can depend upon the type of water being treated. For wastewater containing higher amounts of grease or oil, a larger diameter of media may be desired.

In some implementations, filter —Ag/carbon filters can include one or more of gravel, garnet, a carbon source, filter —Ag, and HDPE spheres. Each of these components will now be described.

In accordance with some aspects, filter —Ag/carbon filters include a washed gravel under bedding (⅛″ to ¾″ average particle size). Filter sand size, angularity and hardness are characteristics that can be selected depending upon the application.

In some implementations, filter —Ag/carbon filters further include a high-density granular filter material, such as garnet. Garnet is a high hardness, high density granular filter media. Garnet has high specific gravity of 4.0, density in the range of 120-150 lbs/ft³, 0.3 mm effective size, and can filter down to the 10-to-20-micron range. Garnet's hardness reduces attrition and provides for years of reliable service. Garnet is typically provided as the lower (final) filtration bed of a multi-bed down flow filtration system. In some aspects, other aluminum silicate minerals may be utilized as the high-density granular filter material. In some aspects, illustrative aluminum silicate materials include, but are not limited to, garnet, Almandine (Fe₃Al₂(SiO₄)₃), Pyrope (Mg₃Al₂(SiO₄)₃), and Spessartine (Mn₃Al₂(SiO₄)₃). Some high iron content minerals may also be used.

In some implementations, filter —Ag/carbon filters can include a carbon source. Carbon has been used for filtration and purification for thousands of years. Depending on the type, carbon is used for adsorption, absorption, and/or as an oxidation catalyst. Source material for activated carbon media includes bituminous and anthracite coal, bone char, coconut shell, lignite, peat, bamboo, sawdust, peach pits, coir, petroleum pitch, and wood. Activated carbon is derived from a carbonaceous source material.

In some aspects, these source materials are crushed, sized, and processed with intense heat to create what is known as activated carbon. The activation process opens the pores of a carbon filter, increasing the surface area and giving the carbon more capacity to hold contaminants. Activated carbon removes contaminants through adsorption of contaminants onto the surface and pores of a carbon granule. These activated carbon granules are porous and have an extensive internal and external structure of activation sites. The most common types of activated carbon used in water treatment are the granular and powdered forms. Powdered activated carbon is used in many carbon block filters and point of use filters. Granular activated carbon is most common in point of entry backwashing and flow through filter systems. Activated carbon is often used to improve the taste and odor of water. Applications include the removal of hydrogen sulfide, chlorine and chloride reduction, MTBE and PFAS removal. The ability of activated carbon to both adsorb and absorb makes it one of the best filter media in the water treatment industry. The only regeneration needed is backwashing and rinsing. No chemical regenerants are needed

In some implementations, the carbon source comprises catalytic carbon high activity (60%) and granular activated carbon (GAC) coconut shell high activity (40%). GAC coconut shell is prepared from the shell of a coconut.

In accordance with some embodiments, Filter —Ag can form the larger, less dense layers of the carbon filter. Filter —Ag is a non-hydrous silicon dioxide media which can be used as highly efficient filter media for the reduction of suspended matter (e.g., sediment). It is a lightweight granular-type filter material used to remove turbidity from water.

Filter —Ag can provide advantages over the more common granular filter medias used for suspended solids reduction. In some aspects, Filter —Ag can provide an advantageous combination of particle shape, size, and density. This media contains fractured edges and irregular surface that provide a high surface area and complex flow path for efficient removal of suspended matter throughout the filter bed, typically reducing suspended solids down to the 20- to 40-micron range.

In some aspects, the larger particle size of Filter —Ag can create less pressure loss through the carbon filter and allow deeper sediment penetration into the bed for higher sediment loading and longer filter runs. This large and irregular shape can prevent the screening and caking of sediment in the top several inches of the carbon filter bed that can occur in the typical sand filter, thus preventing a rapid buildup of headloss and blinding problems.

In some implementations, the lighter weight of Filter —Ag results in lower backwash rates and better bed expansion required to release trapped sediment and rinse the filter media during the backwash cycle.

In some aspects, carbon filters include solid high-density polyethylene (HDPE) spheres. These solid spheres can float on the surface of liquid, thereby greatly reducing the amount of media floating past the valve body. As the plastic spheres are backwashed with the media beds, they create spaces within the media bed and ensure the spheres are forced back to the top of the tank. In these aspects, all media can be cleaned, and the entire surface area is sufficiently exposed. The plastic itself can have better chemical resistance to certain compounds that are typically found in laundry facility effluent.

In accordance with some embodiments, filter —Ag/carbon filters can be designed to keep the filter bed clean and expose the filter media bed to as much surface area as possible. In some aspects, the presence of HDPE spheres can provide benefits such as separation of precipitated organics while keeping them in solution, as well as preventing channeling in the carbon filter tank.

Treated wastewater can be passed to drain or reused as feedwater to the laundry process. The continuously treated water meets environmental criteria for groundwater discharge. In some implementations, treatment methods can provide an essentially continuous operation, with minimal downtime and maintenance, which maintenance can be readily and simply achieved such as by regular but infrequent filter cleaning or replacement.

Wastewater treatment systems described herein can provide a number of features. For example, methods and systems described herein can provide significant reductions in energy and water costs associated with processing large quantities of laundry. In some implementations, methods and systems described herein can be utilized by motels and hotels, laundromats, uniform shops and virtually any type of facility where a laundry-type operation is in place.

In some aspects, treatment systems can be housed in a room adjacent to a laundry facility, in an adjacent shed-type structure, on the roof of a building, or wherever appropriate for a given situation.

In some aspects, wastewater recovery systems and methods can provide a streamlined process that eliminates steps and/or equipment previously used for similar wastewater treatment. For example, in some implementations, treatment methods and systems do not require or include illumination with ultraviolet light. In some embodiments, treatment methods and systems do not include more than one carbon filtration step (i.e., only a single filtration step using filter —Ag/carbon filter is performed). This can save time, money, and footprint.

Optional components include any one or more of the following, additional screening (such as lint remover steps), coagulation, or membrane filtration.

In some implementations, methods for treatment of laundry wastewater can comprise steps of:
subjecting effluent from laundry operations to grinder pumps to reduce particulate size in the effluent;
subjecting the effluent to a lint remover;
separating debris of a predetermined size from the effluent by subjecting the effluent to a multimedia filter;
ozonating the effluent within an ozone treatment chamber; and
subjecting the effluent to a filter —Ag/carbon filter.

In accordance with some aspects, laundry effluent passes from one or more conventional washing machines (raw water supply 4 in FIG. 1) into grinder pumps 6. Once larger particulate matter is macerated in grinder pumps 6, the effluent moves to lint remover 8, which can be a lint shaker, a series of pressurized filter bags, a spin disk assembly, or other lint removal assembly. The output of the lint remover 8 then flows to sediment filter 10 for removal of particulate above a designated size (e.g., 50 μm). The filtered effluent then moves to ozone treatment chamber 14, where it is subjected to ozone treatment for a desired period of time. Ozone generator 12 provides ozone bubbles, which are passed through the water in the ozone treatment chamber 14 to oxidize surfactants present in the water as a result of cleaning chemicals found in detergents. Ozone is a microcoagulant and binds to particles, causing them to coagulate and float, facilitating removal from the effluent. After ozonation, the effluent can pass to a final filter —Ag/carbon filter treatment step, which removes any remaining organic matter and chemicals. In the filter —Ag/carbon filter treatment step, laundry effluent is treated with a multi-component carbon filter assembly that can include one or more of gravel, a high-density granular filter material, a carbon material, Filter —Ag plus, and HDPE spheres. In some implementations, backwashing of the carbon filter can help regenerate the media and redistribute the assembly materials so that process water can “find” and adsorb clean carbon while travelling through the filter material.

In some aspects, the water output from the activated filter —Ag/carbon filter can then pass to a drain area (for release to the wastewater stream) or be reused in the laundry operation. In some implementations, methods and systems can thus provide a single-pass, continuous method for treatment of laundry wastewater. In some aspects, methods can operate at relatively high speeds in a continuous manner.

In some implementations, methods and systems can provide treated water having, at continuous flow of about 25,000 gallons per day, one or more of the following characteristics: pH in a range of 6.5 to 8.5, TSS 30 mg/L or less, TDS 1000 mg/L or less, oil and grease 15 mg/L or less, surfactants (MBAS) 1 mg/L or less.

In some implementations, methods and systems provide an unique configuration and combination of physical, chemical and adsorption techniques to remove materials from laundry effluent. In some aspects, ultraviolet irradiation, a step commonly required in commercial water treatment, is not a process step or assembly component in treatment methods and systems described herein. In some implementations, components of the system can work cooperatively to macerate waste and grind large particulate matter into smaller particles or a fine slurry, filter particulate matter, oxidize surfactants and heavy metals, and adsorb any remaining chemical compounds in laundry wastewater. In some aspects, the particular order and combination of components of the water treatment system provide benefits described herein.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained.

In the specification and in the claims, the terms “including” and “comprising” are open-ended terms and should be interpreted to mean “including, but not limited to . . . .” These terms are broader than, and therefore encompass, the more restrictive terms “consistently essentially of” and “consisting of.”

As used herein and in the appended claims, the singular forms “a,” “an,” and “the” include plural reference unless the context clearly dictates otherwise. As such, the terms “a” (or “an”), “one or more” and “at least one” can be used interchangeably herein.

We claim:

1. A laundry wastewater recovery system comprising:
one or more grinder pumps for receiving raw wastewater from laundry operations;
a lint remover in fluid communication with the grinder pumps;
a sediment filter in fluid communication with the lint remover;
an ozone treatment chamber in fluid communication with the sediment filter; and
a filter ag/carbon filter.

2. The laundry wastewater recovery system of claim 1 wherein the grinder pumps are selected from semi-positive displacement (SPD) pumps or centrifugal pumps.

3. The laundry wastewater recovery system of claim 1 wherein the lint remover comprises a vibrating filter screen.

4. The laundry wastewater recovery system of claim 1 wherein the lint remover comprises one or more mesh screens.

5. The laundry wastewater recovery system of claim 1 wherein the lint remover comprises one or more pressurized filter bags.

6. The laundry wastewater recovery system of claim 1 wherein the sediment filter comprises a 50 μm sediment filter containing sand.

7. The laundry wastewater recovery system of claim 1 further comprising an ozone destruction unit.

8. The laundry wastewater recovery system of claim 1 wherein the filter ag/carbon filter comprises gravel, a high-density granular filter material, activated carbon, GAC coconut shell, Filter-Ag plus and HDPE spheres.

9. The laundry wastewater recovery system of claim 8 wherein the high-density granular filter material comprises garnet.

10. A method for treatment of laundry wastewater, the method comprising steps of:
subjecting effluent from laundry operations to grinder pumps to reduce particulate size in the effluent;
subjecting the effluent to a lint remover;
separating debris of a predetermined size from the effluent by subjecting the effluent to a multimedia filter;
ozonating the effluent within an ozone treatment chamber; and
subjecting the effluent to a filter ag/carbon filter.

11. The method of claim 10 wherein the step of subjecting effluent from laundry operations to a lint remover comprises subjecting effluent from a plurality of washing machines.

12. The method of claim 10 wherein the step of subjecting effluent from laundry operations to a lint remover comprises subjecting effluent to a vibrating filter screen.

13. The method of claim 10 wherein the method does not include a step of subjecting the effluent to ultraviolet light.

14. The method of claim 10 wherein the step of ozonating the effluent comprises ozonating the effluent within an ozone treatment chamber for 10 to 30 minutes.

15. The method of claim 10 further comprising a step of recycling water from the filter ag/carbon filter back into the laundry operation.

16. The method of claim 10 further comprising a step of passing water from the filter ag/carbon filter into a wastewater stream.
